(19) United States
(12) Patent Application Publication
(10) Pub. No.: US 2010/0275240 A1
(43) Pub. Date: Oct. 28, 2010

(54) TELEVISION SIGNAL RECEIVER, A TELEVISION SIGNAL RELAY SYSTEM, AND A TELEVISION SIGNAL BROADCAST SYSTEM

(76) Inventor: Patrick Lin, Taipei (TW)

Correspondence Address: NIKOLAI & MERSEREAU, P.A., 900 SECOND AVENUE SOUTH, SUITE 820, MINNEAPOLIS, MN, 55402, US

(21) Appl. No.: 12/431,067

(22) Filed: Apr. 28, 2009

(51) Int. Cl. H04H 20/02; H04N 7/26

(52) U.S. Cl. 725/149; 348/384.1; 348/E07.001

(57) ABSTRACT

A television signal receiver is provided that includes: a television tuner module, a compression unit, and a transmission unit. Therein the television tuner module is for outputting a television data stream to the compression unit; the compression unit is for compressing the television data stream then outputting a compressed television data stream; next the transmission unit outputs the compressed television data stream; wherein the compression technique used by the compression unit is by compressing and converting each image within the television data stream into a dynamic image for sequential output.

### BACKGROUND OF THE INVENTION

1. Field of the Invention

The present invention relates to a receiver, in particular, to a television signal receiver.

2. Description of Related Art

Watching television has become an important entertainment for people, wherein the signals for the television can be categorized into analog television signal and digital television signal. Therein, analog television signal has been developed for a long time and is widely used, and some common ways to receive and view the analog television signal is by directly installing an antenna or connecting to a television cable that is provided by the cable television industry.

However with the progression of computer technology, computer may now also function in conjunction with a television tuner so as to receive and view television signals. Yet, in terms of a computer receiving and viewing digital television, due to the limitations of digital television cable acting as a fixed transmission route, so that it is inconvenient to move and relocate the computer (such as a notebook computer) to different locations for viewing.

On the other hand, current high level mobile phones have the capability to directly receive and view digital television signal, however the majority of common mobile phones still lacks the function of broadcasting digital television signals, due to the fact that a common mobile phone can only provide limited processing power; therefore, even if the common mobile phone externally connects with a digital television receiver, the common mobile phone would still have the limitation of being incapable of broadcasting digital television signals. Therein, the fact that the common mobile phone cannot perform decompression processing to the output signal of the digital television receiver constitutes as a primary reason for the aforementioned limitation; furthermore the output signal of the digital television receiver has a set requirement for transmission bandwidth, and the transmission interface for a common mobile phone often has difficulty in satisfying such requirement.

### SUMMARY OF THE INVENTION

In view of the aforementioned issues, the present invention provides a television signal receiver, a television signal relay system, and a television signal broadcast system, so that through appropriate image compression processing, the output signal of the television signal receiver may be received and broadcast more easily, thereby resolving the aforementioned issues of the prior art.

In order to achieve the aforementioned objectives, the present invention provides a television signal receiver according to an embodiment of the present invention, which includes: a television tuner module, a compression unit and a transmission unit. Therein, the television tuner module is for outputting and providing a television data stream to the compression unit, so that the compression unit may compress the television data stream via a compression technique then outputting a compressed television data stream. The transmission unit is for outputting the processing result of the compression unit, such as the compressed television data stream. Therein the compression technique is by compressing and converting each image within the television data stream into a dynamic image for sequential output.

To achieve the aforementioned objectives, the present invention further provides a television signal relay system according to another embodiment of the present invention, which includes: a television signal receiver and a wireless transmitter. Therein the television receiver includes a television tuner module, a compression unit, and a transmission unit; the television tuner module is for outputting and providing a television data stream to the compression unit, so that the compression unit may compress the television data stream via a compression technique then outputting a compressed television data stream; the transmission unit is for outputting the processing result of the compression unit, such as the compressed television data stream; and the compression technique is by compressing and converting each image within the television data stream into a dynamic image for sequential output. The wireless transmitter is coupled to the television signal receiver, for wirelessly outputting the compressed television data stream.

To achieve the aforementioned objectives, the present invention further provides a television signal broadcast system according to another embodiment of the present invention, which includes: a television signal receiver and a portable electronic device. Therein the television receiver includes a television tuner module, a compression unit, and a transmission unit; the television tuner module is for outputting and providing a television data stream to the compression unit, so that the compression unit may compress the television data stream via a compression technique then outputting a compressed television data stream; the transmission unit is for outputting the processing result of the compression unit, such as the compressed television data stream; and the compression technique is by compressing and converting each image within the television data stream into a dynamic image for sequential output. The portable electronic device includes a display monitor. The portable electronic device is coupled to the television signal receiver, for receiving, decompressing, and then outputting the compressed television data stream for broadcast on the display monitor.

Therefore through the aforementioned technical proposal of the present invention, the following efficacy is achieved: the compression technique used by the television signal receiver may reduce the bandwidth requirement for the television data stream, thereby the required hardware-resource may be lowered at the receiving terminal for the digital data stream, so that the television data stream can be transmitted, received, and broadcasted easier.

In order to further understand the techniques, means, and effects the present invention takes for achieving the prescribed objectives, the following detailed descriptions and appended drawings are hereby referred; such that, through which the purposes, features, and aspects of the present invention can be thoroughly and concretely appreciated; however, the appended drawings are merely provided for reference and illustration, without any intention to be used for limiting the present invention.

### BRIEF DESCRIPTION OF THE DRAWINGS

FIG. 1 is a function block diagram of a television signal receiver according to an embodiment of the present invention;

FIG. 2 is a schematic diagram of a television signal relay system according to an embodiment of the present invention;

FIG. 3 is a function block diagram of a wireless transmitter according to an embodiment of the present invention;

FIG. 4 is a schematic diagram of a television signal broadcast system according to an embodiment of the present invention; and

FIG. 5 is a schematic diagram of the television signal broadcast system according to another embodiment of the present invention.

### DETAILED DESCRIPTION OF THE PREFERRED EMBODIMENTS

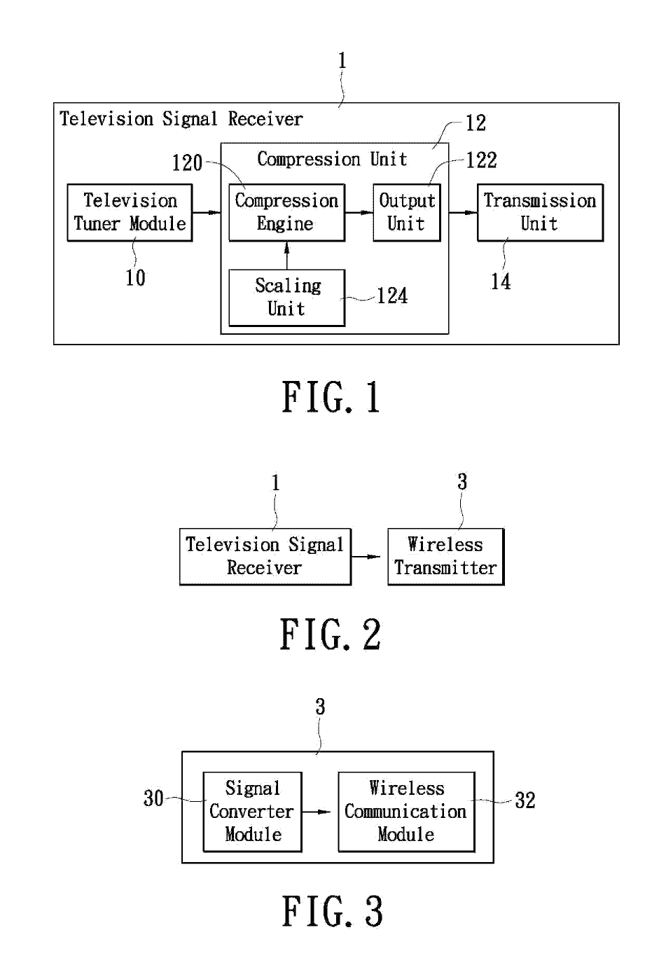

First please refer to FIG. 1, which shows a function block diagram of a television signal receiver according to an embodiment of the present invention. The television signal receiver 1 of FIG. 1 includes a television tuner module 10, a compression unit 12, and a transmission unit 14; wherein the television tuner module 10 can be used to receive and process a television signal into a television data stream for output to the compression unit 12; furthermore the television tuner module 10 is a hardware module that can be used to receive digital television signal or analog television signal.

The compression unit 12 is coupled to the television tuner module 10, for receiving the television data stream, and for performing compressing to the television data stream, so that the amount of transmitted data for the television data stream may be greatly reduced. More specifically speaking, the compression unit 12 includes a compression engine 120, an output unit 122, and a scaling unit 124. Therein the compression engine is for receiving the television data stream, and then providing image compression processing at a set compression ratio for each image within the television data stream; then the output unit 122 sequentially outputs the each image according to processing result of the compression engine 120, so as to form a compressed television data stream for dynamic image output. The scaling unit 124 is for controlling the compression ratio of the compression engine 120, wherein the compression ratio may be adjusted to determine the data size for each of the compressed image. The aforementioned compression technique used by the compression unit 12 is primarily according to a motion-JPEG compression technique.

The transmission unit 14 is coupled to the output terminal of the compression unit 12, and is for outputting the compressed television data stream that has last been output by the compression unit 12 to an external wireless electronic device for wireless transmitting or to an electronic device for direct broadcasting. The present embodiment of the present invention ideally uses USB transmission interface for the transmission unit 14. Through the universality of the USB transmission interface, the television signal receiver 1 may achiever easier connection with an external electronic device for data transmission. For actual implementation, the aforementioned scaling unit 12 and transmission unit 14 may be integrated on an integrated circuit, so that the size of the television signal receiver 1 may be reduced.

Next is the explanation of a few possible operating ways for the aforementioned television signal receiver 1. Please refer to FIG. 2, which shows a schematic diagram of a television signal relay system according to an embodiment of the present invention, and primarily includes a television signal receiver 1 and a wireless transmitter 3. Therein, the wireless transmitter 3 primarily provides wireless relay transceiving function for television signals; thereby a remote electronic device may transceive and broadcast the television signal.

Furthermore, please refer to FIG. 3; the wireless transmitting unit 3 includes a signal converter module 30 and a wireless communication module 32. Therein the signal converter module 30 is coupled to the transmission unit 14 of the television signal receiver 1. Due to the fact that the communication protocol format used for data transmission is different between the wireless communication module 32 and the transmission unit 14, therefore a conversion of the communication protocol format must be provided while data transmission is occurring between the two, in order to facilitate successful transmission of the data between the two. Therefore the signal converter module 30 is primarily for converting the compressed television data stream between a communication protocol format of the transmission unit 14 and a communication protocol format of the wireless communication module 32, so that the wireless communication module 32 can wirelessly output the compressed television data stream. The aforementioned communication protocol format of the wireless communication module 32 is applicable for wireless fidelity (Wi-Fi).

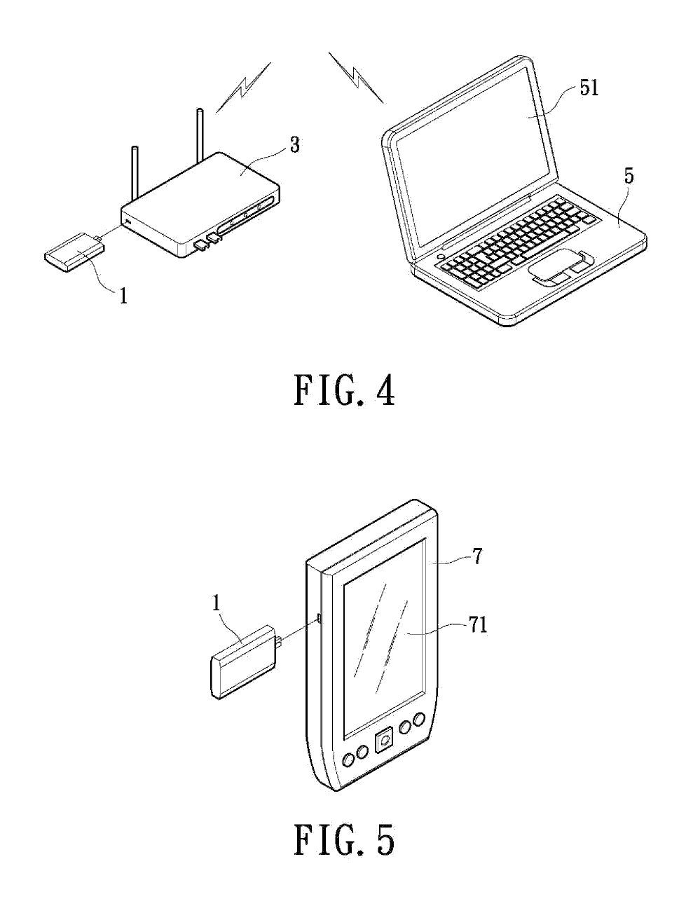

In accordance with the system structure disclosed in FIG. 2, the television signal relay system can be further utilized for application, such as according to FIG. 4 which shows a schematic diagram of a television signal broadcast system according to an embodiment of the present invention. Therein, the television broadcast system is based on the aforementioned structure of the television signal relay system that further includes a terminal device 5. The terminal device 5 primarily receives the compressed television data stream that has been output by the television signal relay system in a wireless way; then the terminal device 5 performs decompression image processing to the received compressed television data stream, so as to obtain the original television signal; and subsequently the television signal is broadcast on the display monitor 51 of the terminal device 5.

The wireless communication of the aforementioned terminal device 5 is compatible with the communication format used by wireless transmitter 3, furthermore the broadcasting function of the terminal device 5 supports motion-JPEG decompression technique, and the terminal device 5 may be a personal computer, a palm's pilot, or a notebook computer.

Regarding the system structure shown in FIG. 4, a specific example is cited here to explain its operation. If a digital signal receiver 1 is for receiving an analog television signal (such as receiving an indoor cable television (CATV)), the wireless transmitter 3 is located in the living room and the terminal device 5 is located in another room, then although the living room and another room has a certain distance, but the terminal device 5 can still wirelessly receive the decompressed television data stream that has been output by the wireless transmitter 3 that is located in the living room. Thereby, this allows the user to wireless view the incoming television signal in any room within the house.

Furthermore, please refer to FIG. 5, which shows a schematic diagram of the television signal broadcast system according to another embodiment of the present invention. Therein, the television signal broadcast system includes a television signal receiver 1 and a portable electronic device 7. The television signal receiver 1 can be used to receive digital television signal, and the transmission unit 14 of the television signal receiver 1 can be connected to the connection interface of the portable electronic device 7. Through the aforementioned connection, the portable electronic device 7 can directly receive the compressed television data stream that has been output by the television signal receiver 1, and furthermore can perform decompression image processing to the received decompressed television data stream, so as to obtain the original television signal. The television signal can then be broadcast on a display monitor 71 of the portable electronic device 7.

The connection interface used by the aforementioned portable electronic device 7 is compatible with the transmission format used by the transmission unit 14 of the television signal receiver 1. For example, the connection interface can be a USB interface, and the broadcasting function of the portable electronic device 7 may support motion-JPEG decompression technique, furthermore the portable electronic device 7 may be a personal computer, a palm's pilot, or a notebook computer.

Regarding the system structure shown in FIG. 5, through the connecting way demonstrated by FIG. 5, those portable electronic device 7 on the current market that originally can not directly broadcast digital television signal, can now obtain the function of receiving and broadcasting digital television signal via connecting to a television signal receiver 1.

As per the aforementioned embodiments, the television signal receiver 1 especially uses the motion-JPEG compression technique, and the application of this technique results in reduced hardware cost when compared with using the MPEG-2 technique; furthermore the device that is for receiving the output signal of the television signal receiver 1 does not need to be burdened with the complicated operation of MPEG-2 compression-decompression technique. As long as the device supports the motion-JPEG compression technique, then the device can broadcast television signals without high level processing hardware, so that the present invention allows many portable electronic devices on the current market to directly obtain the function of broadcasting television signals.

Furthermore, for the present invention, another advantage of the television signal receiver 1 for using the motion-JPEG image compression technique is that the required transmission bandwidth is less than using the MPEG-2. Thereby the television signal receiver 1 can be used more easily with the transmission interface of related electronic devices, such as the aforementioned USB interface of the transmission unit 14, however the present invention is not intended to be limited thereby, and other transmission interface may be used as long as the transmission bandwidth of the transmission unit 14 is compatible with the transmission requirement for the compressed television data stream.

Additionally, the television signal receiver 1 of the present invention is applicable for receiving analog television signal or digital television signal; for example when receiving analog television signal, an indoor cable television through combination of the television signal receiver 1 and a wireless transmitter 3, may remotely operates and broadcast television signal; or for another example, when receiving digital television signal, the television signal receiver 1 may directly connect with a portable electronic device 7, so as to perform the operating and broadcasting of television signals.

The aforementioned descriptions represent merely the preferred embodiment of the present invention, without any intention to limit the scope of the present invention thereto. Various equivalent changes, alternations, or modifications based on the claims of present invention are all consequently viewed as being embraced by the scope of the present invention.

What is claimed is:

1. A television signal receiver, comprising:
a television tuner module, for outputting a television data stream;
a compression unit, for compressing the television data stream via a compression technique then outputting a compressed television data stream; and
a transmission unit, for outputting the compressed television data stream;
wherein the compression technique is by compressing and converting each image within the television data stream into a dynamic image for sequential output.

2. The television signal receiver according to claim 1, wherein the television tuner module is for receiving analog television signal or digital television signal.

3. The television signal receiver according to claim 1, wherein the compression unit compresses:
a compression engine, for receiving the television data stream, and then providing image compression processing for each image within the television data stream; and
an output unit, for sequentially outputting the dynamic image according to the processing result of the compression engine so as to form the compressed television data stream.

4. The television signal receiver according to claim 3, further compressing:
a scaling unit, for controlling the compression ratio of the compression engine that is applied to the image compression processing for each image.

5. The television signal receiver according to claim 1, wherein the compression technique used by the compression unit is a motion-JPEG compression technique.

6. The television signal receiver according to claim 1, wherein the transmission unit is a USB transmission interface.

7. The television signal receiver according to claim 1, wherein the compression unit and the transmission unit are integrated on an integrated circuit.

8. A television relay system, comprising:
a television signal receiver, comprising:
a television tuner module, for outputting a television data stream;
a compression unit, for compressing the television data stream via a compression technique then outputting a compressed television data stream; and
a transmission unit, for outputting the compressed television data stream;
wherein the compression technique is by compressing and converting each image within the television data stream into a dynamic image for sequential output; and
a wireless transmitter, coupled to the television signal receiver, for wirelessly outputting the compressed television data stream.

9. The television signal relay system according to claim 8, wherein the compression technique used by the compression unit is a motion-JPEG compression technique.

10. The television signal relay system according to claim 9, wherein the wireless transmitter comprises:
a wireless communication module, for wirelessly transmitting the compressed television data stream; and
a signal converter module, coupled to the transmission unit, for converting the compressed television data stream between a communication protocol format of the transmission unit and a communication protocol format of the wireless communication module.

11. The television signal relay system according to claim 10, wherein the communication protocol format of the transmission unit is applicable for USB, and the communication protocol format of the wireless communication module is applicable for wireless fidelity (Wi-Fi).

12. A television signal broadcast system, comprising:
a television signal receiver, comprising:
a television tuner module, for outputting a television data stream;
a compression unit, for compressing the television data stream via a compression technique then outputting a compressed television data stream; and
a transmission unit, for outputting the compressed television data stream;
wherein the compression technique is by compressing and converting each image within the television data stream into a dynamic image for sequential output; and
a portable electronic device, which includes a display monitor, the portable electronic device is coupled to the television signal receiver, for receiving, decompressing, then outputting the compressed television data stream for broadcast on the display monitor.

13. The television broadcast system according to claim 12, wherein the compression technique used by the compression unit is a motion-JPEG compression technique.

14. The television broadcast system according to claim 12, wherein the portable electronic device is a mobile phone, a smart phone, or a personal digital assistant (PDA).
